(19) United States
(12) Patent Application Publication
(10) Pub. No.: US 2016/0249173 A1
(43) Pub. Date: Aug. 25, 2016

(54) Method, device and system for navigating a site.

(71) Applicant: APPSARE.US INC., Montreal (CA)

(72) Inventors: Jacques Dubernat, Bordeaux (FR); Olivier Heu, Outremont (CA)

(21) Appl. No.: 15/049,539

(22) Filed: Feb. 22, 2016

Related U.S. Application Data
(60) Provisional application No. 62/120,052, filed on Feb. 24, 2015.

(51) Int. Cl. H04W 4/02; H04W 40/24; H04W 4/00

(52) U.S. Cl. CPC H04W 4/026; H04W 4/008; H04W 40/244; H04W 84/12

(57) ABSTRACT

Method, device and system for navigating a site on which beacons are located, the method including traveling from beacon to beacon to reach a destination without requiring a plan to scale of the site.

### FIELD OF THE INVENTION

The present invention relates to the general field of navigation, and is more specifically concerned with a method, device and system for navigating a site.

### BACKGROUND

Navigation in open spaces has become pervasive in recent years due to the integration of the global positioning system (GPS) devices in smart phones. However, the GPS signal is typically unavailable indoors. Accordingly, smart phones and order similar devices cannot be used typically indoors to guide people through unfamiliar sites.

Other signals, such as Wi-Fi and Bluetooth signals, are sometimes used to provide navigation on such sites. To that effect, signal emitters are provided at many locations on the site. However, such systems are relatively expensive, either due to the number of signal emitters required to completely cover a site, or to complexity of such signal emitters.

Accordingly, there exists a need for an improved method, device, and system for navigating a site. It is a general objective of the present invention to provide such an improved device, improved system and improved method.

### SUMMARY OF THE INVENTION

In a broad aspect, the invention provides a method usable by an intended user for navigating a site using a navigation device, said site including beacons detectable by said navigation device, said method comprising: a) receiving from said intended user a destination on said site; b) detecting when said navigation device is adjacent of one of said beacons; c) determining an orientation of said navigation device; d) presenting to said intended user information indicative of a direction to take to reach said destination or another one of said beacons closer to said destination than said one of said beacons; e) repeating steps b to d until said user is at said destination.

Instead of using the strength of signals to triangulate the position of the intended user, the proposed method relies on a network of beacons providing a graph representing the site. Navigation from an initial location to a destination is made by navigating the graph or, in other words, by going from beacon to beacon. This type of navigation requires less precision than signal intensity-based navigation involving triangulation, and may also require the use of a smaller number of signal emitting devices. Indeed, taking for example the case of a very long corridor, there is no need to add beacons all along the corridor if there are no branches. All that is required is a beacon close to the entrance of the corridor and another one at the end of the corridor.

Other objects, advantages and features of the present invention will become more apparent upon reading of the following non-restrictive description of preferred embodiments thereof, given by way of example only with reference to the accompanying drawings.

### BRIEF DESCRIPTION OF THE DRAWINGS

In the drawings:

FIG. 1, in a schematic view, illustrates a site to navigate using methods provided by the present invention;

FIG. 2, in a block diagram, illustrates a navigation system usable on the site of FIG. 1;

FIG. 3, in a flowchart, illustrates a method of initialization to be performed to be able to navigate the site of FIG. 1 using the navigation system of FIG. 2;

FIG. 4, in a flowchart, illustrates a method for performing a step of creating an orientation table that is part of the method of FIG. 3;

FIG. 5, in a flowchart, illustrates a method for associating orientations and destinations that is part of the method of FIG. 4;

FIG. 6, in a flowchart, illustrates a method for navigation the site of FIG. 1 using the navigation system of FIG. 2;

FIG. 7, in a flowchart, illustrates a method for assisting a user in selecting a beacon among many detected beacons;

FIG. 8, in a flowchart, illustrates a method for performing a step of displaying beacon symbols part of the method of FIG. 7;

FIG. 9, in a schematic view, illustrates a geometry usable for displaying beacon symbols in the method of FIG. 8;

FIGS. 10A to 10C, in screen captures, illustrate beacon symbols corresponding to various distances with the corresponding beacons; and

FIG. 11, in a schematic view, illustrates a relationship between a beacon symbol size and distance from the corresponding beacon usable in the method of FIG. 8.

### DETAILED DESCRIPTION

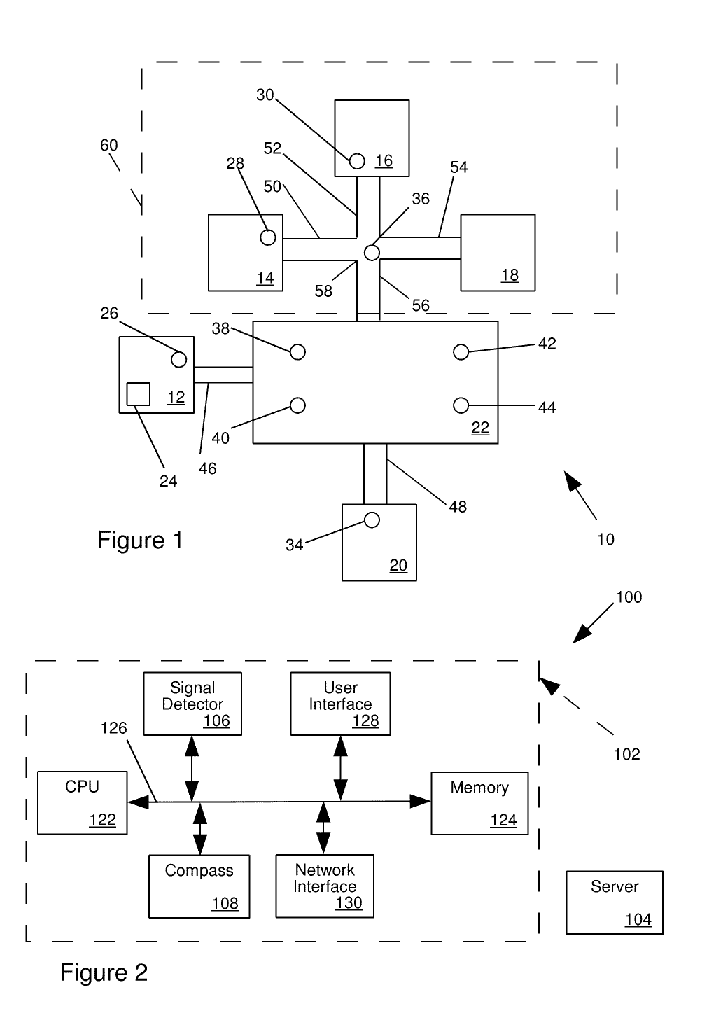

With reference to FIG. 1, there is shown an example of a site 10 that will be used in the description of the present invention. While the site 10 represented in FIG. 1 is in the form of a building, the present invention is usable in any suitable type of sites, including outdoor sites. Accordingly, while FIG. 1 illustrates a site 10 including rooms, in other embodiments, the different locations on the site 10 may be any other suitable contiguous area of the site 10. It should be understood that the site 10 is only for example purposes and does not limit the scope of the present invention. The site 10 includes a number of rooms 12, 14, 16, 18, 20 and 22. Rooms 12 to 20 are for the purpose of this example relatively small. Room 22 is much larger than rooms 12 to 20. The site is to be navigated by an intended user 24, here represented in room 12. Beacons 26 to 44 are provided in the rooms 12 to 22 and in some embodiments in at least some of the corridors 46 to 54 linking the rooms 12 to 22 to each other, for example at intersection 58.

Corridor 46 extends between rooms 12 and 22. Corridor 48 extends between rooms 20 and 22. Corridors 50, 52, 54 and 56 extend respectively from rooms 14, 16, 18 and 22 and all intersect at intersection 58. Beacons 26, 28, 30 and 34 are provided respectively in rooms 12, 14, 16 and 20. Beacons 38 to 44 are all provided in the room 22, for example each in a respective quadrant thereof. Beacon 36 is located at intersection 58. For the purpose of this example, rooms 14, 16 and 18, along with corridors 50, 52, 54 and 56 form a region 60, the purpose of which will be described in further details hereinbelow. A region 60 for the purpose of this document includes a section of the site 10, typically contiguous, used to facilitates navigation, typically in large sites 10.

Beacons 26 to 44 are devices that emit a signal, typically a radio frequency signal, to be picked up by a suitable navigation device 102 illustrated in FIG. 2 and described in further details hereinbelow. The signal includes information allowing identification of the specific beacon 26 to 44 that emits the signal. It should be noted that other types of signals are usable with the present invention, including for example ultrasound signals, among others. A specific embodiment of the beacons 26 to 44 includes Bluetooth beacons, and more specifically Bluetooth low energy (BLE) beacons. BLE beacons are devices that emit simple Bluetooth signals, consisting of an identifier of the beacon. This identifier may be unique to the beacon or shared by a number of beacons. The power with which the signal is emitted may be adjusted or set, but is not varied once adjusted. BLE beacons are well known in the art and will not be described in further details hereinbelow. The reader skilled in the art will understand that other suitable types of beacons, including but not limited to other types of Bluetooth beacons or Wi-Fi beacons are usable with the present invention.

In the example shown in FIG. 1, rooms 12, 14, 16 and 20 are relatively small. Accordingly, only one beacon 26, 28, 30 and 34 is required in each of these rooms 12, 14, 16 and 20 as the signal emitted by this beacon 26, 28, 30 and 34 is powerful enough to be detected over the whole room 12, 14, 16 and 20. It should be near noted that in some embodiments, no beacon is provided in at least some rooms, for example as in room 18 in FIG. 1. Room 22 is a relatively large room so that using only one beacon would not ensure coverage of the whole room 22. Accordingly, four beacons 38, 40, 42 and 44 are used to ensure that the navigation device 102 will pick up a signal at any location in the room 22. The four beacons 38, 40, 42 and 44 may all broadcast the same identifier or different identifiers. In the first case, only determination that one is located within the room 22 may be made. In the second case, a more precise location of the specific portion of the room 22 in which the intended user 24 may be located is made possible.

FIG. 2 illustrates in a block diagram a navigation system 100 usable on site 10. The navigation system 100 includes a navigation device 102 and a server 104. The navigation device 102 is usable both to navigate the site 10 and to initialize the navigation system 100 so that the navigation system 100 may be used to navigate the site 10. Typically, different physical navigation devices 102 having similar hardware are used to initialize the navigation system 100 and to navigate the site 10, but in other embodiments the same navigation device 102 is used for both actions.

The navigation device 102 includes a Central Processing Unit (CPU) 122 connected to a memory unit 124 over a data bus 126. Although the memory unit 124 is shown as a single block, it may include a plurality of separate components, such as Read Only Memory (ROM), Random Access Memory (RAM), flash memory, or a hard disk, among others. The navigation device 102 also includes a user interface 128 usable by the intended user 24, a signal detector 106 and a compass 108 that all connect to the data bus 126. When the navigation device 102 is in use, the memory unit 124 holds a program element executed by the CPU 122, the program element implements one or more of methods 200 to 700 described hereinbelow. In some embodiments, a network interface 130, such as a wireless network interface (for example a Wi-Fi interface), is also part of the navigation device 102 and communicates with the CPU 122 and/or the memory unit 124 through the data but 126.

The intended user 24 communicates with the navigation device 102 through the user interface 128. In a non-limiting example of implementation, the user interface 128 includes a touch screen. The user interface 128 is configured both to communicate information to the intended user 24 and to receive inputs therefrom, for example to receive input data therefrom or to control the operation of a program element executed by the CPU 122. The user interface 128 may include in some embodiments, for example, any one or a combination of the following: display unit, camera, keyboard, pointing device, touch sensitive surface or speech recognition unit, among others.

The signal detector 106 includes hardware and software required to detect and characterize the signals emitted by the beacons 26 to 44. For example, the beacons 26 to 44 emit radio-frequency signals and the signal detector 106 includes an antenna, amplifiers and circuitry required to detect the intensity of the signal received and decode its contents. The signal may be analog or digital, depending on the embodiment of the invention. This intensity and contents may be provided to the CPU 122 through the data bus 126. In some embodiments, directional information indicating the direction from which a signal is emitted relative to the navigation device 102 may also be similarly provided. Typically, the signal detector 106 is able to receive signals from many of the beacons 26 to 44 and separate these signals from each other.

The compass 108 detects the orientation of the navigation device 102 relative to a reference orientation. The compass 108 may use a magnetometer and/or inertial detection to provide heading, and in some embodiments roll and pitch information. Orientation information is provided to the CPU 122 over the data bus 126.

The server 104 is typically a general-purpose computer having a network interface. The server 104 may communicate with the network interface 130 to exchange information with the navigation device 102. The architecture of the server 104 is typically similar to that of the navigation device 102, except that usually no compass 108 and signal detector 106 is provided therein. In some embodiments, no server 104 is required to operate the navigation system 100 as all data is stored on the navigation device 102.

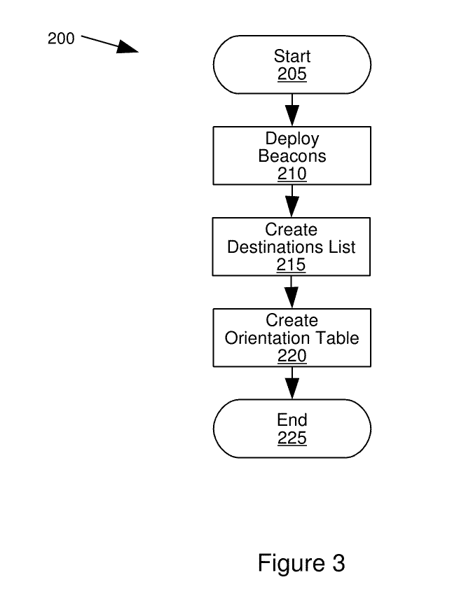

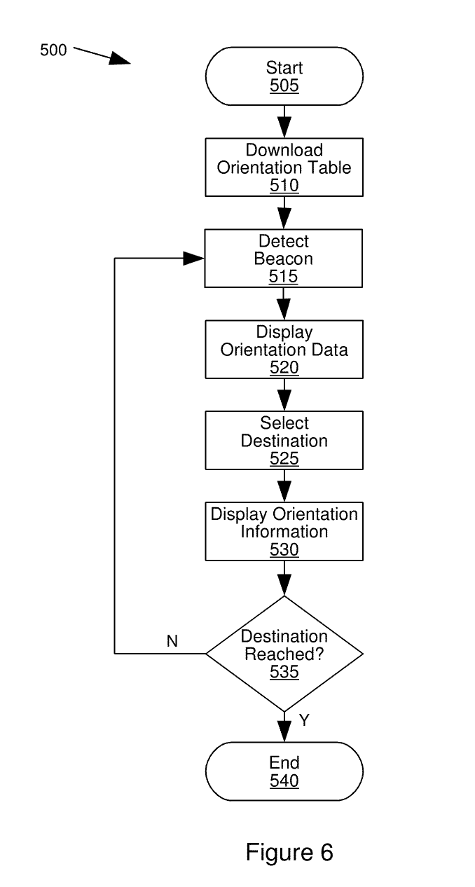

There are two steps in the use of navigation system 100. The first step is initialization that must be performed when a site 10 is first setup. The second step is navigation which is performed once initialization has been performed. Initialization is performed through initialization method 200 shown in FIG. 3. Navigation is performed through navigation method 500 shown in FIG. 6.

Referring to FIG. 3, there is shown the initialization method 200. Initialization method 200 starts at step 205. Then, at step 210, the beacons 26 to 44 are deployed. Subsequently, at step 215, a destination list is created and at step 220, an orientation table is created. Finally, the method ends at step 225. The initialization method 200 may be performed on a site 10 that previously did not include any beacon 26 to 44, or to add beacons 26 to 44 to a site that previously included such beacons 26 to 44, or to modify a site 10, with or without moving any of the beacons 26 to 44.

At step 210, the beacons 26 to 44 are deployed on the site 10. The beacons 26 to 44 are first programmed to broadcast an identifier identifying each beacon 26 to 44. The beacons 26 to 44 may all have different identifiers, or some subgroups of the beacons 26 to 44 may share a common identifier. In some embodiments, the power with which the identifier is broadcast can be also programmed. Then, the thus programmed beacons 26 to 44 are physically located at suitable locations on the site 10. Typically, the beacons 26 to 44 are located at locations at which the intended user 24 needs to make a choice while navigating the site 10, or at locations from which the intended user 24 may start or finish navigation on the site 10. Positioning of the beacons 26 to 44 is selected so that the navigation device 102 can easily detect them with high reliability. Deployment of the beacons 26 to 44 may be made using empirical rules, simulators indicating the power of their signal in on the site 10 or through trial and error using the navigation device 102 to detect power of the signal emitted by each beacon 26 to 44 as they are deployed at many locations on the site 10.

At step 215, the destination list is created. Destinations are locations on the site 10 that the intended user 24 may wish to reach. For example, rooms 12, 14, 16, 18 and 20 may be destinations. In another example, the destination is a portion of a room, such as the corner of room 22 closest to the beacon 42. Destinations may be located on different floors in a building. Destinations are created at initialization, not by the intended user 24 wishing to navigate the site 10. The intended user 24 selects from the destination list when navigating, as described in further details hereinbelow. The destination list is stored on the server 104 and/or in the memory unit 124. The destination list includes information characterizing each destination, such as a name in alphanumeric characters. The destination list may also include other information, such as a picture of the destination. The destination list may be created on the navigation device 102 using the user interface 128, or using any other device, such as the server 104 or another computer, laptop or tablet. In some embodiments, there are many destinations that are close to each other. These destinations could be grouped in a region, such as region 60 for the site 10. Step 215 may then include creating a list of such regions 60, the list also including the destinations that are within each region 60. The purpose of regions 60 is detailed hereinbelow.

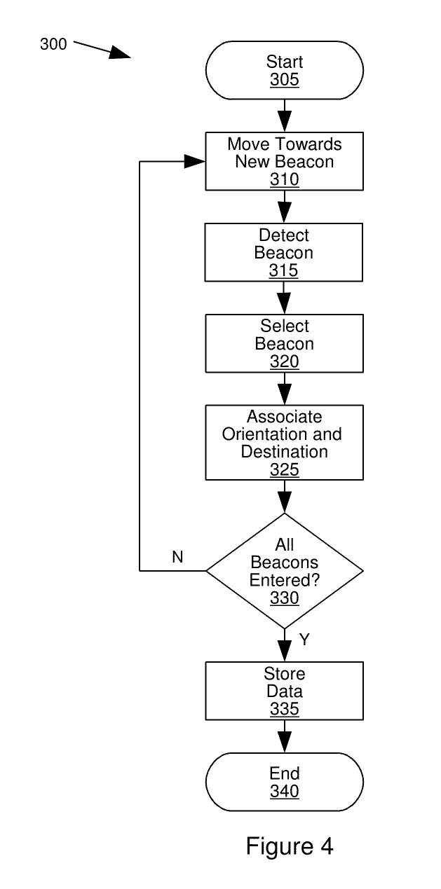

At step 220, an orientation table is created. The orientation table includes information indicative of a direction towards which the intended user 24 needs to move to reach each destination, or at least a subset of the destinations, when each of the beacons 26 to 44 is reached. Step 220 is illustrated in FIG. 4 which includes a flowchart of an example of an orientation table creation method 300.

Method 300 starts at step 305. Then, at step 310, the intended user 24 moves towards one of the beacons 26 to 44 for which no orientation data is available while carrying the navigation device 102, or a beacon 26 to 44 for which orientation data must be added, removed or altered. Then, at step 315, when the intended user 24 approaches one of the beacons 26 to 44, say for example beacon 36, the navigation device 102 picks up the signal emitted by the beacon 36 using the signal detector 106 and indicates to the intended user 24, using the user interface 128, that the beacon 36 is in proximity to the intended user 24. Then, at step 320, the intended user indicates to the navigation device 102, through the user interface 128, that the beacon 36 is to be selected. Subsequently, at step 325, the intended user 24 associates an orientation with at least some destinations from the destination list for the beacon 36. If the beacon 36 reached is at one of the destinations from the destination list, this information is entered in the orientation table instead of entering directions. At step 330, the intended user determines if all beacons on the site 10 have been entered in the destination list. If not, the method 300 loops back to step 310. Otherwise, the method proceeds to step 335 to store the orientation table on the server 104, if needed, and then ends at step 340.

Step 315 involves many activities in the navigation device 102. In some embodiments, the signal detector 106 sends to the CPU 122 information indicative of all beacons 26 to 44 within detection range, including the intensity of the signal detected for each and their identifier, and the CPU 122 processes this information to select the beacon 36 closest to the intended user 24, that is usually the beacon 26 to 44 for which the signal intensity is the largest. In some embodiments, the CPU 122 further applies a threshold to the signal intensity so that the beacon 36 is considered detected if the signal intensity is above a predetermined threshold. In other embodiments, no such processing is required as the intended user 24 will move by himself adjacent the beacon 36 as the location of the beacon 36 is known.

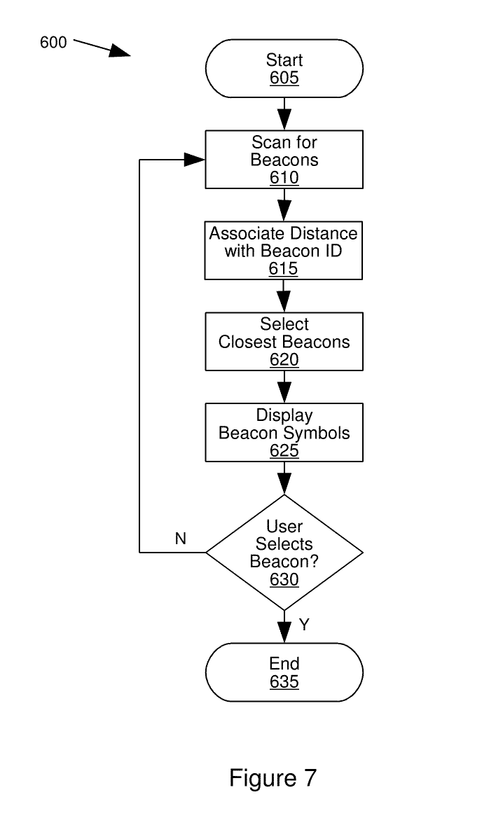

Regarding step 320, in some embodiments, determination that a certain beacon 36 has been reached is made automatically by the navigation device 102, for example using thresholding as described hereinabove, and this beacon 36 is automatically selected. In other embodiments, information, such as signal intensity and identifier, regarding one, some, or all of the beacons 26 to 44 detected is presented to the intended user 24 through user interface 128 and the intended user selects which beacon 36 will be used for the moment to enter corresponding orientation data. This presentation and selection may also be made using the selection method 600 presented in FIG. 7.

Step 335 is optional as the orientation table may be stored in memory unit 124. However, in some embodiments, it is convenient to store the orientation table on a server 104 so that it can be accessed later depending on which site 10 the intended user 24 is, and so that updates to the orientation table can be presented.

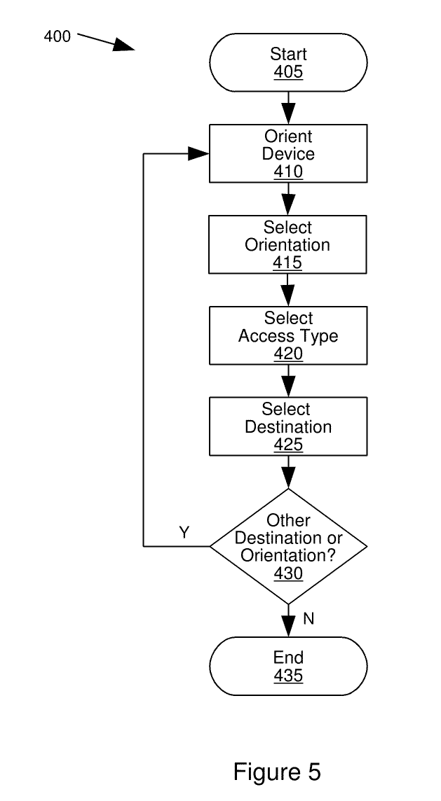

Method 400, shown in FIG. 5, may be used at step 325. Method 400 starts at step 405. Then, at step 410, the intended user 24 faces an orientations towards which the intended user 24 must move to reach at least one of the destinations. Once the intended user 24 faces this orientation, at step 415, the intended user 24 indicates through the user interface 128 that this orientation at the selected beacon 36 is to be selected. The orientation is detected using the compass 108. In some embodiments, step 420 allows selection of a type of access associated with the destination and, if applicable, entry of auxiliary information is made through the user interface 108. Then, at step 425, the intended user uses the user interface 128 to select which one, or which ones, of the destinations is to be associated with the orientation selected at step 415 in the orientation table. Afterward, at step 430, the intended user 24 indicates to the navigation device 102, through the I/O interface 128, if there are more orientations to select for the specific beacon 36 at which the intended user 24 is located, which results in the method 400 looping back to step 410, or if the intended user 24 may move to another beacon 26 to 44, at which point method 400 ends.

Step 420 includes adding information related to actions that the intended user 24 should take to reach a destination using navigation device 102. For example, in some embodiments, the user interface 128 is used to take a picture of a specific feature towards which the intended user 24 would move to reach the destination. For example, if reaching the destination requires going through an elevator, step 420 may include taking a picture of this elevator to be stored in the orientation table also. Also, auxiliary information could be entered using the user interface 128, such as textual information providing information of where the intended user should go. For example, if the intended user 24 should take the elevator to reach the destination, a message indicating that the elevator should be taken up to the 3^{rd} floor, for example, could be entered and stored in the orientation table. It should be noted that the orientation may point directly towards the destination or the orientation may point towards another beacon 26 to 44 towards which the intended user must move to reach the destination. Therefore, for each beacon 26 to 44, there is a list of destinations and for each destination, a specific orientation is stored. The orientation table contains all information that is thought to be necessary for the intended user 24 to navigate to the destinations from the beacon 36.

In some embodiments, there are many destinations that are close to each other. These destinations could be grouped in a region, such as region 60 for the site 10. Then, instead of indicating in the orientation table all destinations reachable from each beacon 26 to 44, when the intended user 24 is outside of the region 60, only the region 60 needs to be specified and the navigation device 102 may either use this region information while navigating so that all destinations within the region 60 are treated similarly, or the navigation device 102 may populate the orientation table with all destinations within the region 60 without the intended user entering all these destinations. For example, for beacon 40, rooms 14, 16 and 18 are within region 60. When at beacon 40, the intended user 24 would point towards the access to corridor 56 and indicate that the corresponding orientation is associated with region 60. Later, when navigating the site 10, the intended user 24 will be told through the navigation device 102 to go towards corridor 56 when the destination is any one of rooms 14, 16 and 18.

Once all beacons 26 to 44 have been visited, initialization is complete and the intended user 24 may perform navigation method 500 shown in FIG. 6. It should be noted that the intended user 24 typically changes between methods 200, in which the intended user 24 is for example an employee performing method 200, and the method 500 in which the intended user 24 is for example a visitor of the site 10.

Method 500 starts at step 505. Then, at step 510, the orientation table for the site 10 is downloaded by the navigation device 102 from the server 104 through the network interface 130. Subsequently, at step 515, the navigation device 102 detects one or more beacons 26 to 44 and one of the beacons 26 to 44 is selected. Then, at step 520, the orientation table data is displayed to the intended user 24 for the selected beacon by displaying one or more destinations reachable from the beacon 26 to 44 selected at step 515, and the intended user 24 selects one of these destinations at step 525, steps 520 and 525 being performed using the user interface 128. Once a destination is selected, at step 530, the orientation towards which the intended user should move to reach the selected destination is displayed using the user interface 128, along with any pictures and/or auxiliary data associated with this destination. Afterward, at step 535, if the destination is not reached or reachable following the displayed information, method 500 loops back to step 515. Otherwise, method 500 goes to step 540, at which point method 500 ends.

In step 510, the orientation table could be downloaded for the whole site 10, or only for beacons 26 to 44 detectable by the navigation device 102. Also, in some embodiments, only orientation table data associated with beacons 26 to 44 within detection range by the signal detector 106 is downloaded. In these embodiments, steps 510 and 515 are reversed with step 515 being performed before step 510. In yet other embodiments, the orientation table for site 10 is already stored in the memory unit 106 and does not need to be downloaded, so that step 510 is omitted.

In step 515, the navigation device 102 uses the signal detector 106 to provide to the CPU 122 information regarding one or more beacons 26 to 44 detectable using the signal detector 106. One of these beacons 26 to 44 is selected as being the one for which orientation data is to be provided. In some embodiments, selection of the beacon 26 to 44 is made automatically by the navigation device 102, for example using thresholding to identify a beacon 26 to 44 for which the intensity of the signal is above a predetermined threshold selected to indicate proximity to the beacon 26 to 44. In other embodiments, information, such as signal intensity and identifier, regarding one, some, or all of the beacons 26 to 44 detected by the signal detector 106 is presented to the intended user 24 through I/O interface 128 and the intended user selects which beacon 26 to 44 will be selected using the I/O interface 128. This presentation and selection may be made for example using the selection method 600 presented in FIG. 7.

In step 520, the orientation table data from the orientation table for the selected beacon 26 to 44 is presented. For example, all access points through which the intended user 24 must pass to reach one or more destinations are displayed on a display part of the user interface 128, along with identification of one or more destinations reachable through the access point. Examples of access points include doors, elevators and corridors, among others. The access points are in some embodiments displayed in list format. In other embodiments, the navigation device 102 uses the orientation of the navigation device 102 obtained from the compass 108 to display the access points roughly according to the direction towards which the intended user 24 should move to reach them. For example, a schematic or exact plan of the location surrounding the beacon 26 to 44 selected is displayed with the beacon 26 to 44 selected at the center of the display, and access points roughly or exactly where they are in space, in orientation and/or distance on the plan relative to the beacon 26 to 44. Then, the intended user may select which destination is to be reached, for example by tapping on the part of a touch screen part of the user interface 128 showing a symbol or characters indicative of this destination. It should be noted that in some embodiments, the destination is selected once in the whole navigation process and only access point and orientation table data corresponding to this destination is displayed at step 520. Step 525 then becomes unnecessary.

At step 530, the navigation device 102 uses the compass 108 to determine the orientation of the navigation device 102 and displays to the intended user 24 a direction towards which the intended user 24 should move to reach the selected destination. For example, an arrow pointing towards the direction towards which the intended user 24 should move to reach the selected destination is displayed on a display part of the user interface 128. Also, in some embodiments, the access point corresponding to the selected direction could be highlighted on the plan used in step 520. If available, a photograph of the access point and auxiliary information may also be provided on the display.

FIG. 7 illustrates a method 600 performed by the navigation device 102 to allow selection of one of the beacons 26 to 44 when many beacons 26 to 44 are within detection range. Method 600 is usable in methods 300 and 500 at steps 320 and 515, respectively, as mentioned hereinabove. However, method 600 is usable in any other context wherein there is a need of selecting a beacon when many are detected. Generally speaking, method 600 represents all or some of the detected beacons 26 to 44 on a display by displaying a symbol for these beacons 26 to 44 detected along a line extending between the center of a polygon and a vertex of the polygon. Each beacon is associated with a respective vertex.

More specifically, method 600 starts at step 605. Then, at step 610, the navigation device 102 scans for beacons 26 to 44 detectable using the signal detector 106 and associates with the identifier of each detected beacon 26 to 44 an estimated distance at step 615. Steps 610 and/or 615 may be omitted if the information they provide is already available, for example if method 600 is part of a more complex method. Afterward, at step 620, up to a maximal number of beacons 26 to 44 are selected and beacon symbols 804 corresponding to these beacons 26 to 44 are displayed on the user interface 128 of the navigation device 102 at step 625. Then, at step 630, the navigation device 102 determines if one of the beacon symbols 804 is selected by the intended user 24, for example by detecting that of one of the beacon symbols 804 displayed at step 625 has been tapped on a touch screen part of the user interface 128. If the beacon symbol 804 corresponding to one of the beacons 26 to 44 is selected, the method continues to step 635, at which point the method ends. Otherwise, the method loops back to step 610 to update if required the detected beacons list. When appropriate, after the method 600 has ended, a predetermined action associated with the beacon 26 to 44 associated with the selected beacon symbol 804.

Step 610 is performed using method well known in the art. For example, most Bluetooth enabled devices, such a the navigation device 102 in the form of a smart phone, for example, include the necessary software and hardware to detect other Bluetooth devices, for example with the beacons 26 to 44 taking the form of BLE beacons.

At step 615, for each detected beacon 26 to 44, the intensity of the signal is used to estimate a distance between the beacon 26 to 44 and the navigation device 102. It should be noted that in some embodiments, this distance estimate may have a relatively large error without unduly affecting the method 600. The distance is not used per se to determined the position of the navigation device 102 relative to the beacons 26 to 44, for example using triangulation. This distance is only used to select which beacons 26 to 44 are close to the navigation device 102 so that information related thereto can be displayed to the intended user 24. In some embodiments, the distance is simply estimated using a power law in which the distance is inversely proportional to a power of the signal intensity, for example to the square of the signal intensity. In other embodiments, the distance estimate uses previously acquired empirical data related to each beacon 26 to 46 so that the distance takes into account the electromagnetic properties of the environment of the beacon 26 to 44 and the specific shape of the electromagnetic field emitted by the beacon 26 to 44. The previously acquired data maps the signal intensity for each beacon 26 to 44 as a function of distance from the beacon 26 to 44. For example, one factor that may affect distance determination is the angular orientation relationship between the broadcasting antenna of the beacons 26 to 44 and the receiving antenna of the signal detector 106, which affects the intensity of the signal detected by the signal detector 106. Once the orientation of the broadcasting antenna is known, the compass 108 may provide an indication of the spatial orientation of the receiving antenna. Using this information, the estimated distance between the beacon 26 to 44 and the navigation device 102 may be better determined by introducing a corrective factor dependent on the relative orientation between the broadcasting and receiving antennas. The orientation of the broadcasting antenna may be determined either theoretically, taking into account the position and physical orientation of the beacons 26 to 44, or empirically when the site 10 is first setup by using a suitable detector, such as the signal detector 106, which may be used to characterize the electromagnetic field emitted by the broadcasting antenna, which depends on the orientation of the broadcasting antenna. Similar improvements in distance estimation may also be used at any other steps described in the present document wherein a distance between the navigation device 106 and a beacon 26 to 44 is determined. In yet other embodiments, the signals from all beacons 26 to 44 detectable at a certain location are used to determine, again using empirical data, the distance to each beacon 26 to 44. For example, a beacon 26 to 44 located around a corner may only be weakly detected. However, for example, previous information about other beacons 26 to 44 may indicate that when a certain subset of those beacons 26 to 44 is detected, a weak signal from the beacon 26 to 44 that is just around the corner indicates that in fact this beacon 26 to 44 is close to the navigation device 102, and that the corresponding distance thereto is small.

At step 620, all the identified beacons 26 to 44 are sorted, for example in order of decreasing distance from the navigation device 102, and only up to a predetermined number of these beacons 26 to 44 are selected for use in step 625. It should be noted that if method 600 is iterated repeatedly, it may be advantageous to depart from a strict “minimal distance” criteria to select beacons 26 to 44. Indeed, in some embodiments, due to the nature of the signal emitted by the beacons 26 to 44, the signal intensity may vary rapidly in time, for example when people and objects move between the navigation device 102 and the beacons 26 to 44. In these embodiments, it may be advantageous to select beacons 26 to 44 that are not the closest, but which were previously selected, for a predetermined duration after they have moved out of the list of closest beacons. The predetermined duration may be for example one, two or 5 seconds, among other possibilities. The same may be applied to beacons 26 to 44 that were previously detected, but that are subsequently undetected. In these embodiments, it may be advantageous to keep on selecting these beacons 26 to 44 for a predetermined number of iterations of the method 600, or for a predetermined duration. In some embodiments, a visual indication is provided to the intended user 24 to indicate that a certain beacon is no longer detected, for example by blinking the beacon symbol 804 associated therewith.

Step 625 displays on the use interface 128 symbols for all the beacons 26 to 44 selected at step 620. While in theory the identifier of the beacons 26 to 44 could be displayed, this would be highly user unfriendly. Instead, the beacons 26 to 44 are represented as symbols having identical, similar or different shapes. For example, in a method 700 described in further details hereinbelow, the beacons 26 to 44 are displayed as disks filled with a picture related to the beacon 26 to 44. The picture may for example show the location at which the beacon is located. In other embodiments, the picture is related to an action to be performed by the navigation device 102 once the symbol corresponding to one of the beacons 26 to 44 is selected. In yet other embodiments, the symbol includes alphanumeric characters related to the location of the beacon 26 to 44.

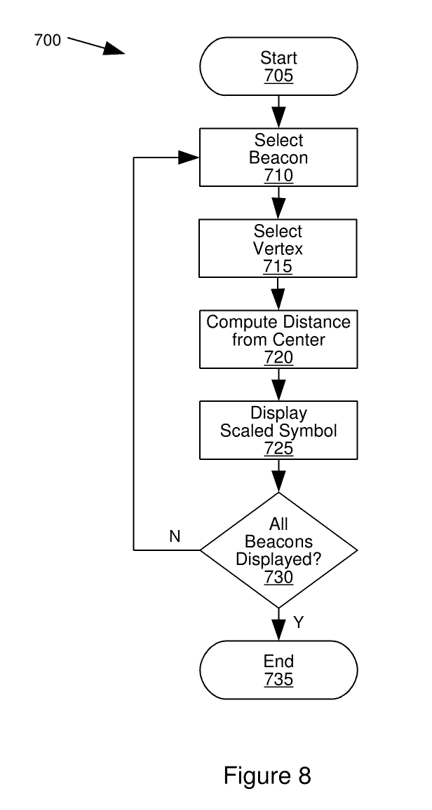

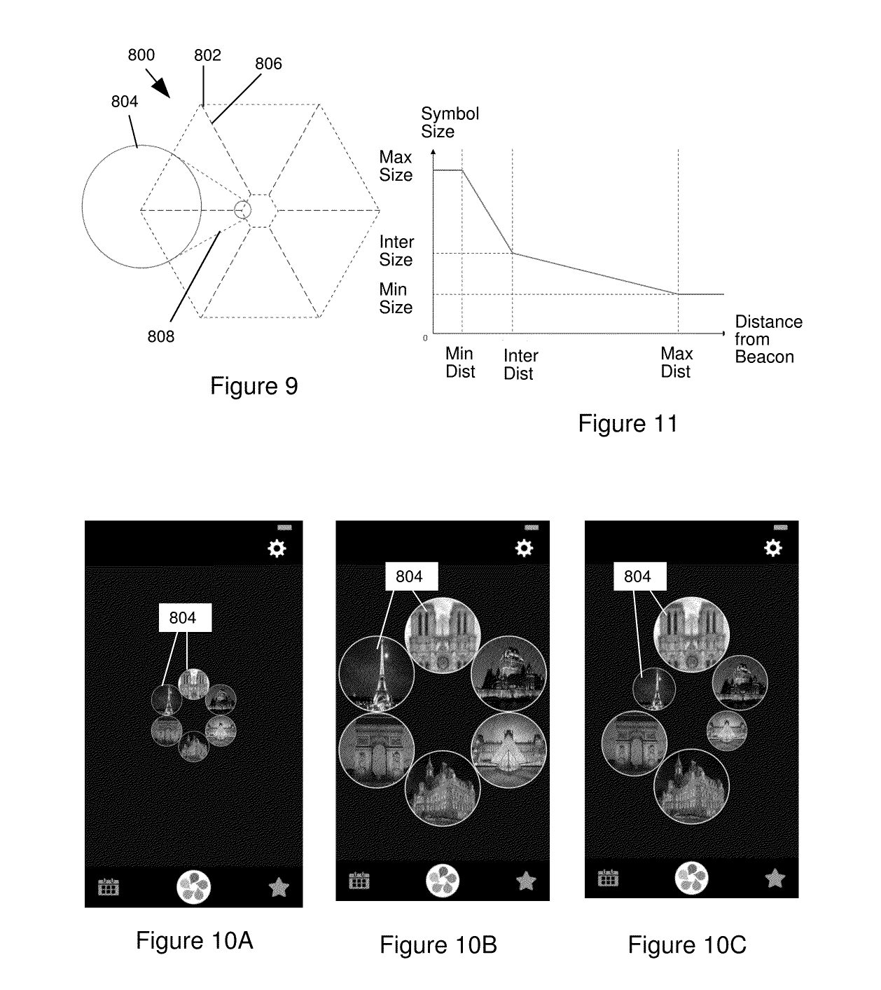

FIG. 8 is a flowchart of an example of a method 700 usable for displaying beacon symbols 804 at step 625 of method 600. With reference to FIG. 9, a predetermined maximal number of beacon symbols 804 is displayed according to a polygonal geometry 800 having a number or vertices equal to the predetermined maximal number. In the example shown in FIG. 9, this predetermined maximal number is 6 and the beacon symbols 804 are displayed on an hexagonal geometry. More specifically, each beacon symbol 804 is associated with a vertex 802 of the polygonal geometry 800. The beacon symbols 804 are in this embodiment disc shaped, but other suitable shapes are within the scope of the invention. Also, the beacon symbols 804 are all disc shaped, but it is within the scope of the invention to have symbols 804 having shapes differing from each other.

Distance between the navigation device 102 and each selected beacon 26 to 44 is conveyed in two manners. First, closer beacons 26 to 44 are represented by beacon symbols 804 having larger dimensions, such as larger diameters. Second, the distance between the beacon symbol 804 and the center of the hexagonal geometry 800 increases for closer beacons 26 to 44. Each beacon symbol 804 is positioned along a radius 806 of the polygonal geometry 800 intersecting a respective vertex 802. In some embodiments, the radius 806 of the beacon symbol 804 is selected so that each beacon symbol 804 remains confined within one sector 808 from a plurality of equal size sectors 808 each centered on a respective vertex 802.

The relationship between beacon symbol size, for example radius, and distance to beacon 26 to 44 may be linear with or without upper and lower limits. However, it is often more important to clearly distinguish between the beacons 26 to 44 that are closest to the navigation device 102. To that effect, the symbol size—distance from beacon relationship may be as seen in FIG. 11. First, all beacons 26 to 44 closer than a predetermined minimal distance, as estimated, are represented by bacon symbols 804 having predetermined maximal size. This is the case in the screen capture of FIG. 10B, in which 6 beacons are all closer than the predetermined minimal distance. Similarly, all beacons 26 to 44 farther than a predetermined maximal distance, as estimated, are represented by beacon symbols 804 having a predetermined minimal size. This is the case in the screen capture of FIG. 10B, in which 6 beacons are all farther than the predetermined maximal distance. Also, a predetermined intermediate distance is defined. The symbol size—distance from beacon relationship is linear between the predetermined minimal and intermediate distances. The symbol size—distance from beacon relationship is also linear between the predetermined maximal and intermediate distances, but with a different slope. A larger slope is selected for the beacons 26 to 44 closer than the predetermined intermediate distance, which enhances visually the distance variations with closest beacons 26 to 44. In other embodiments, any other suitable symbol size—distance from beacon relationship may be selected. For example, a sigmoid shape could be used, which would result in a smoothed version of the symbol size—distance from beacon relationship illustrated in FIG. 11.

In a very specific and non-limiting example, the beacons 26 to 44 are BLE beacons and the predetermined minimal, intermediate and maximal distances are 0.5, 3 and 6 meters respectively

FIG. 10A illustrate a case in which all beacon symbols 804 have the minimal size. FIG. 10B illustrate a case in which all beacon symbols 804 have the maximal size. FIG. 10C illustrate a more common case in which beacon symbols 804 have different dimensions. It should be noted that if the number of beacon symbols 804 to display is smaller than the number of vertices 802 of the polygon 800, some sectors 808 remain empty.

Returning to FIG. 8, method 700 is now described in further details. Method 700 starts at step 705. Then, at step 710, one of the beacons 26 to 44 selected at step 620 of method 600 is selected for processing. A vertex 802 corresponding to an unoccupied radius of the polygon 800 is selected at step 715. If method 700 is performed after is has been performed previously, it is advantageous, but not required, that the vertex 802 corresponding to a specific beacon 26 to 44 does not change between iterations of the method 700. At step 720, the distance from center along the radius 806 extending to the selected vertex 802 is computed, for example using the relationship of FIG. 11, to determine the symbol size and the appropriate location on the radius 806 is selected so that the symbol 804 is as close to the center of the polygon 800 while remaining entirely within one of the non-overlapping sectors 808. Alternatively, a predetermined distance from center—distance from beacon relationship is used. Then, at step 725, the symbols 804 are displayed along the selected radius 806 at the distance from the center determined in step 720 and scaled to the right symbol dimension using the predetermined symbol size—distance from beacon relationship, such as the one illustrated in FIG. 11, for example. At step 730, if beacon symbols 804 for all selected beacons 26 to 44 have been displayed, method 700 ends at step 735. Otherwise, method 700 loops back to step 710.

Although the present invention has been described hereinabove by way of preferred embodiments thereof, it can be modified, without departing from the spirit and nature of the subject invention as defined in the appended claims.

What is claimed is:

1. A method usable by an intended user for navigating a site using a navigation device, said site including beacons detectable by said navigation device, said method comprising:
a) receiving from said intended user a destination on said site;
b) detecting when said navigation device is adjacent of one of said beacons;
c) determining an orientation of said navigation device;
d) presenting to said intended user information indicative of a direction to take to reach said destination or another one of said beacons closer to said destination than said one of said beacons;
e) repeating steps b to d until said user is at said destination.

2. The method as defined in claim 1, wherein said beacon are Bluetooth Low Energy (BLE) beacons

3. The method as defined in claim 1, wherein said navigation device is a smart phone.

4. The method as defined in claim 1, further comprising receiving from a server a navigation table, said navigation table including a sequence of said beacons to follow to reach said destination from at least one of said beacons and information indicative of a direction to take to reach at each point in said sequence to reach a next one of said beacons in said sequence , step (d) including obtaining said information from said navigation table.

5. The method as defined in claim 1, wherein step (c) includes using a compass to obtain said orientation.
